(19) United States
(12) Patent Application Publication
(10) Pub. No.: US 2012/0197480 A1
(43) Pub. Date: Aug. 2, 2012

(54) LINE REPLACEABLE UNIT WITH INTEGRAL MONITORING AND DISTRIBUTED ARCHITECTURE COMPRISING SUCH A UNIT

(75) Inventors: Marc Tony BENINCA, Bagneux (FR); Jean-Rémi André MASSE, Saint Cloud (FR); Marc MISSOUT, Montigny le Bretonneux (FR)

(73) Assignee: SNECMA, Paris (FR)

(21) Appl. No.: 13/362,809

(22) Filed: Jan. 31, 2012

(30) Foreign Application Priority Data
Feb. 1, 2011 (FR) 1150758

(51) Int. Cl. G01M 17/00; G06F 19/00

(52) U.S. Cl. 701/29.9

(57) ABSTRACT

A line replaceable unit for aircraft, the line replaceable unit including: a measuring device configured to measure useful data to define the status of the line replaceable unit, a predictive monitoring device configured to calculate indicators of potential breakdown of the line replaceable unit from useful data to define the status of the line replaceable unit, a communication interlace capable of forwarding indicators of potential breakdown to a central unit.

### CROSS-REFERENCE TO RELATED APPLICATIONS

This application claims the benefit of priority from French Patent Application No. 1150758 filed on Feb. 1, 2011, the entire content of which is incorporated herein by reference.

### FIELD

The present invention relates to the general field of predictive monitoring of the status of a unit for an aircraft engine in order to predict maintenance operations which have to be carried out on the component.

### BACKGROUND

Currently, aircraft companies demand their aircraft to be operationally available for the longest possible time. To achieve this, aircraft engines have to be operationally available for the greatest possible time. More specifically, said engines generally comprise numerous line replaceable units (also known as LRUs) which in the event of malfunction have to be replaced during maintenance repair operations.

In order to increase the operational availability of the engines, it is necessary to predict when the line replaceable units have to be removed. This prevents the working operations being interrupted by maintenance or repair operations.

In order to be able to plan the maintenance of line replaceable units, engine manufacturers have therefore developed devices and methods for predictive monitoring of line replaceable units.

The predictive monitoring methods for line replaceable units generally comprise a step during which sensors collect useful data to define the status of the line replaceable units. The data are then forwarded to a central unit, which may be central unit dedicated to predictive monitoring of the status of the line replaceable units or a central engine control unit which incorporates a predictive monitoring function of the status of the line replaceable units. The central unit then processes the data which it has received in order to deduce therefrom the status of the line replaceable units and to carry out diagnostics enabling the optimal moment for changing said line replaceable units to be predicted.

However, the solutions of the prior art have many drawbacks. Firstly, the volume of data which the central unit has to manage is very high, which means that the central unit has to be provided with a high storage capacity.

Secondly, the central unit generally has to provide all the necessary calculations for the engine control system and, as a result, the addition of supplementary calculations for the monitoring may prove difficult, or even impossible.

Moreover, in order to carry out the diagnostics concerning the status of the line replaceable units, the central unit has to store in its memory reference models for each line replaceable unit. The data received by the central unit are then compared with said reference models. However, the reference models are very complex and require very large computing capacities.

Moreover, the central unit has to be capable of adapting the reference models which it uses to the configuration in which each line replaceable unit is located. More specifically, changing a line replaceable unit entails changing the reference model, since a new unit is not able to be compared with the same model as a unit at the end of its service life or a unit which has already been in operation during flight. Monitoring the change in the status of the line replaceable units, therefore, has to be recommenced each time the unit is changed. With the current solutions, this can only be carried out in monitoring stations on the ground.

Furthermore, there is a great disparity between the different line replaceable units. More specifically, only one average reference model which does not guarantee accuracy is currently used for all said line replaceable units.

This lack of accuracy requires operations to correct the reference model which are not controlled and which may conceal the true extent of wear and tear which is not due to changes in equipment or which does not correspond to the nominal operation of the line replaceable units.

When the technology of an LRU changes, to provide monitoring thereof it is necessary to modify the reference model and the monitoring algorithm which is located in the central unit. As the engine manufacturer does not have any control over the new equipment and the wear and tear thereof, it is up to the engine manufacturer to coordinate with the supplier to carry out the appropriate modifications.

### SUMMARY

Aspects of the invention aim to remedy the drawbacks of the prior art by providing a line replaceable unit of which the maintenance may be predicted in a safe and reliable manner.

A further aspect of the invention is to provide a line replaceable unit of which the maintenance may be predicted without it requiring a large memory or powerful computer.

To achieve this, according to an embodiment of the invention, a line replaceable unit for an aircraft engine is provided, the line replaceable unit comprising:
a measuring device configured to measure useful data to define the status of the line replaceable unit,
a predictive monitoring device configured to calculate indicators of potential breakdown of the line replaceable unit from data relative to the status of the line replaceable unit,
a communication interface capable of forwarding indicators of potential breakdown to a central unit.

Thus, in contrast to line replaceable units of the prior art, for which the line replaceable unit only comprises a measuring device and a communication interface which forwards the data obtained by the measuring device to a central unit which then has to calculate the indicators of potential breakdown for all the line replaceable units which are connected thereto, the line replaceable unit according to an embodiment of the invention comprises its own predictive monitoring device which calculates the indicators of potential breakdown only for said line replaceable unit. Thus, each line replaceable unit calculates its own indicators of potential breakdown and only said indicators of potential breakdown are forwarded to the central unit. Thus, the central unit has to manage a volume of data which is much smaller. Moreover, the central unit may have a smaller computing capacity than the central units of the prior art. Thus, the line replaceable unit calculates internally its own indicators of potential breakdown.

The central unit may, therefore, be limited to calculate reference values for the engine control system, such that it no longer needs to be equipped with a high-performing and expensive processor.

Moreover, the configuration management, i.e. the management of the current stage in the service life of the line replaceable unit, is decentralised and it is directly and automatically taken into account when a line replaceable unit is changed.

Furthermore, by locating the monitoring function in each line replaceable unit it is possible to provide more reliable monitoring.

The line replaceable unit according to an embodiment of the invention may also have one or more of the following features, taken separately or in any combination which is technically possible.

Beneficially, the line replaceable unit is a component of an aircraft engine.

Beneficially, the line replaceable unit comprises a memory.

Beneficially, said memory contains at least one reference model, the predictive monitoring device being capable of calculating the indicators of potential breakdown by comparing the data relative to the status of the line replaceable unit with the reference model.

In an embodiment, the reference model is preferably specific to the line replaceable unit in which it is stored.

A specific reference model can be determinate for each line replaceable unit corresponding to his own nominal use. The use of a specific reference model provides accurate measures of comparison.

Thus, each line replaceable unit may contain its own reference model such that it is no longer necessary to provide a complex central reference model integrating the data relative to all the line replaceable units. The ability to incorporate reference models is thus ensured. As the reference model is unique to each line replaceable unit and to its nominal function, the concept of an average reference model is no longer relevant.

Moreover, when a line replaceable unit is replaced by a different line replaceable unit in which different technology is implemented, the new line replaceable unit is directly specified and delivered with its own reference model and a new extraction algorithm for indicators of wear and tear. The modifications are directly implemented by the supplier of the line replaceable unit which simplifies the management of the reference models.

Beneficially, the reference model is recorded during tests making it possible to define the nominal operation of the line replaceable unit. Thus, each line replaceable unit has in its memory its own reference model which actually corresponds to its nominal operation.

In an embodiment, the predictive monitoring device preferably comprise one of the following elements: a microprocessor, a microcontroller, a processor.

The predictive monitoring device preferably comprise an operating time measuring device making it possible to ascertain how long the line replaceable unit has been in operation.

In an embodiment, the predictive monitoring device also preferably comprise at least one extraction algorithm for the indicators of potential breakdown from data relative to the status of the line replaceable unit and from the operating time of the line replaceable unit.

The line replaceable unit is preferably an intelligent component, i.e. a component in which a unit has been incorporated for processing more or less complex information.

According to different embodiments, the line replaceable unit may be:
an intelligent actuator (also known as a “smart actuator”);
an intelligent sensor (also known as a “smart sensor”);
an intelligent filter (also known as a “smart filter”).

A further aspect of the invention relates to a distributed architecture for an aircraft and preferably for an aircraft engine, comprising:
a central unit;
at least one line replaceable unit according to any one of the embodiments;
a communication device between the central unit and the line replaceable unit.

Beneficially, the central unit is also capable of forwarding reference values to the line replaceable unit so as to actuate it.

Beneficially, the distributed architecture comprises a plurality of line replaceable units.

Beneficially, the communication device comprises a low data-rate communication network.

### BRIEF DESCRIPTION OF THE DRAWINGS

Further features and benefits of the invention will be revealed from reading the following detailed description, with reference to the accompanying figures, in which:

FIG. 1 shows a schematic representation of a line replaceable unit according to an embodiment of the invention; and

FIG. 2 shows a schematic representation of a distributed architecture according to an embodiment of the invention.

### DETAILED DESCRIPTION

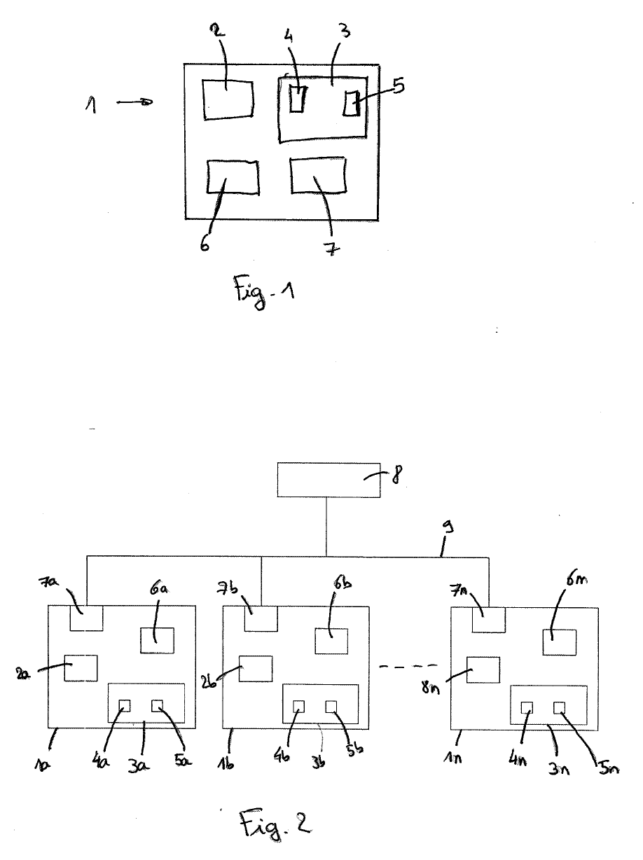

FIG. 1 shows schematically a line replaceable unit 1 according to an embodiment of the invention. The line replaceable unit is also known as an “LRU”.

The line replaceable unit 1 comprises a measuring device 2 capable of measuring useful data to define the status of the line replaceable unit. For example, in the case where the line replaceable unit 1 is a smart actuator, the measuring device may comprise:
a current sensor capable of measuring control currents for the actuator and
a position sensor capable of measuring the positions of the actuator.

In the case where the line replaceable unit 1 is a smart sensor, the measuring device 2 may correspond to the measuring device of the sensor. More specifically, if the smart sensor is a pressure sensor, the measuring device will comprise the pressure sensor.

In the case where the line replaceable unit 1 is a smart filter, the measuring device may comprise pressure sensors permitting the pressure difference between downstream and upstream of the smart filter to be monitored.

The line replaceable unit 1 also comprises predictive monitoring device 3 capable of calculating indicators of potential breakdown of the unit from data relative to the status of the equipment.

Thus, the predictive monitoring device are no longer located in a central unit outside the line replaceable unit 1 and to which all the line replaceable units forward the data measured via the measuring device, but they are located directly in the line replaceable unit which makes it possible to limit the data transfers. Moreover, the predictive monitoring device only have to process the data relative to one line replaceable unit, such that they do not require very high computing power.

In an embodiment, the predictive monitoring device 3 preferably comprises an operating time measuring device 4 which makes it possible to measure how long the line replaceable unit has been in operation. The operating time measuring device may, for example, measure the number of flying hours which the line replaceable unit has carried out since its start-up.

The predictive monitoring device 3 may also comprise an extraction algorithm 5 for the indicators of potential breakdown which makes it possible to make a calculation from different input data. The extraction algorithm may be implemented, for example, in a computer readable medium.

The predictive monitoring device 3 may, for example, consist of a microprocessor or a microcontroller.

Moreover, the line replaceable unit also comprises a memory 6 which, for example, may be the memory of a microprocessor or the microcontroller when the monitoring device comprises a microprocessor or a microcontroller or which may be a separate memory. In the memory 6 at least one reference model is stored, the reference model permitting the predictive monitoring device 3 to define the nominal operation of the line replaceable unit 1. The reference model is preferably set up using tests carried out on the line replaceable unit 1, prior to mounting the line replaceable unit on the aircraft. The reference model is thus preferably specific to the line replaceable unit 1 in which it is stored. Thus an average reference model is no longer used for an assembly of line replaceable units of the same type, such that the predictive monitoring device obtain more accurate results.

The predictive monitoring device 3 internally compares data from the measuring device 2 and the reference model.

For example, in the case where the line replaceable unit 1 is a smart actuator, the predictive monitoring device may compare control currents and position measurements actually obtained by the smart actuator and those provided by the reference model, or monitor the change in the control current in stationary reference conditions, for example in the cruising phase or even monitor the change in the total voltage V1 and V2 of the secondary windings. A method for monitoring the status of a smart actuator is, for example, disclosed in the document FR 1058681. The predictive monitoring device may thus deduce therefrom if the smart actuator is still able to function in an admissible manner in its current state or whether it has to be changed or repaired soon. The predictive monitoring device thus emit indicators of potential breakdown, such as the above examples, which are transmitted to a central unit via a communication interface 7.

In the case where the line replaceable unit 1 is a smart sensor, the predictive monitoring device may establish statistical comparisons between the anticipated values and the measured values so as to establish indicators of potential breakdown. A method for establishing potential breakdown in stationary reference conditions such as the deceleration phase towards the ground or the cruising phase in a smart sensor is, for example, disclosed in the document FR 1059001.

The predictive monitoring device 3 may also take into account the operating time of the line replaceable unit.

The predictive monitoring device 3 determine from all these elements the indicators of potential breakdown which they forward to a central unit via a communication interface 7 which is capable of forwarding the indicators of potential breakdown to a central unit.

The indicators of potential breakdown are generally, according to the examples above, differences between the anticipated values and observed values of control currents, total voltage of secondary windings, actuator positions, average indications or variance of indications during a stationary phase, differences in pressure between downstream and upstream of the filter reduced to reference conditions. The indicators of potential breakdown in a filter serving for filtering a fluid in an aircraft engine are, for example, disclosed in the document FR 0955920.

FIG. 2 shows a distributed architecture for an aircraft according to an embodiment of the invention. The distributed architecture comprises a central unit 8 and a plurality of line replaceable units 1a, 1b . . . 1n. Each line replaceable unit 1a, 1b . . . 1n is similar to the line replaceable unit 1 disclosed with reference to FIG. 1. The line replaceable unit 1a is, for example, a smart actuator. The line replaceable unit 1b is, for example, a smart sensor. The line replaceable unit 1n is, for example, a smart filter. Each line replaceable unit includes a measuring device 2a, . . . 2n, an interface 7a, . . . 7n, a predictive monitoring device 3a, . . . 3n, including an operating time measuring device 4a, . . . 4n and an extraction algorithm 5a . . . 5n, and a memory 6a, . . . 6n.

The central unit 8 is connected to line replaceable units via a communication device 9 which preferably comprise a low data-rate communication network.

The central unit 8 preferably forwards reference values making it possible to monitor the operation of the line replaceable units 1a, 1b . . . 1n.

Moreover, each line replaceable unit 1a, 1b . . . 1n comprises its own predictive monitoring device 3a, 3b . . . 3n as explained above which make it possible to carry out diagnostics for each of the line replaceable units so as to predict the optimum moment to carry out maintenance on said line replaceable units. Thus, each predictive monitoring device 3a, 3b . . . 3n calculates the indicators of potential breakdown making it possible to establish when the maintenance has to be carried out on the equipment to which the predictive monitoring device belong. Only these indicators of potential breakdown are forwarded to the central unit via the communication interface 7a, 7b . . . 7n and via the communication device 9.

Naturally, the invention is not limited to the embodiments disclosed with reference to the figures and numerous variants may be conceived without departing from the scope of the invention. For example, the line replaceable units may be different types of components from those cited with reference to the figures.

1. A line replaceable unit for aircraft, the line replaceable unit comprising a nominal operating mode and comprising:
a measuring device configured to measure useful data to define the status of the line replaceable unit,
a predictive monitoring device configured to calculate indicators of potential breakdown of the line replaceable unit from useful data to define the status of the line replaceable unit,
a communication interface configured to forward indicators of potential breakdown to a central unit,
a memory comprising at least one reference model which corresponds to the nominal operating mode, the predictive monitoring device being configured to calculate the indicators of potential breakdown by comparing the useful data to define the status of the line replaceable unit with the reference model.

2. The line replaceable unit according to claim 1, wherein the reference model is specific to the line replaceable unit.

3. The line replaceable unit according to claim 1, wherein the reference model is recorded during tests making it possible to define the nominal operation of the line replaceable unit.

4. The line replaceable unit according to claim 1, wherein the predictive monitoring device comprises a microprocessor.

5. The line replaceable unit according to claim 1, wherein the predictive monitoring device comprises an operating time measuring device for the unit.

6. The line replaceable unit according to claim 5, wherein the predictive monitoring device comprises at least one extraction algorithm for the indicators of potential breakdown from useful data to define the status of the line replaceable unit and from the operating time of the line replaceable unit.

7. A distributed architecture for aircraft comprising:
a central unit;
at least one line replaceable unit according to claim 1, and
a communication device between the central unit and the line replaceable unit.
